(19) United States
(12) Patent Application Publication
(10) Pub. No.: US 2018/0093504 A1
(43) Pub. Date: Apr. 5, 2018

(54) PRINTER CONTROL METHOD AND PRINTER

(71) Applicant: SEIKO EPSON CORPORATION, Tokyo (JP)

(72) Inventor: Yuichiro KASAI, Suwa-shi (JP)

(73) Assignee: SEIKO EPSON CORPORATION, Tokyo (JP)

(21) Appl. No.: 15/722,568

(22) Filed: Oct. 2, 2017

(30) Foreign Application Priority Data
Oct. 3, 2016 (JP) 2016-195450

(51) Int. Cl. B41J 11/66; B41J 2/32

(52) U.S. Cl. CPC B41J 11/663; B41J 2/32

(57) ABSTRACT

A printer, when cutting a recording sheet by using a movable blade of a cutter, performs concurrently a braking operation of braking the movable blade and a transport operation of transporting the recording sheet for the next printing. Therefore, at the time of continual printing in which printing is continually performed on a plurality of cut sheets, the recording sheet starts to be transported before the movable blade returns to a home position. Thus, throughput improves. Furthermore, since the recording sheet is not transported until the braking operation is started by switching a cutter motor to a braking mode, sheet jam can be inhibited.

### BACKGROUND

### 1. Technical Field

The present invention relates to a printer control method for a printer that includes a cutter and to the printer.

### 2. Related Art

Printers that perform printing on elongated recording sheets of, for example, paper, such as receipts or label sheets, are equipped with cutters for cutting the recording sheets. Such a printer transports a recording sheet along a sheet transport path that extends via a print head and the cutter, performs printing on the recording sheet at a printing position by using the print head, then transports the recording sheet and stops transporting the recording sheet at a cut position at which to cut the recording sheet by the cutter, and drives the cutter to cut the recording sheet.

JP-A-2000-194889 discloses a printer equipped with a cutter. The printer described in JP-A-2000-194889 includes a cutter blade for cutting a recording sheet. The cutter blade is moved from a home position set apart from a sheet transport path to a cutting position on the sheet transport path to cut a recording sheet. A controller of the printer drives the cutter blade to cut the recording sheet and then returns the cutter blade to the home position.

In a related art, a printer equipped with a cutter, after cutting a recording sheet, returns the cutter blade to the home position before restarting transporting the recording sheet. On the other hand, the printer of JP-A-2000-194889 stops transporting a recording sheet, drives the cutter, and, after detecting that the cutter has reached the cutting position, starts transporting the recording sheet. Therefore, the printer can concurrently perform the operation of returning the cutter blade to the home position and the operation of transporting the recording sheet.

In the printer of JP-A-2000-194889, which starts transporting the recording sheet on the basis of detection of the cutter blade at the cutting position, the cutting position is on the sheet transport path. Therefore, there is a possibility that the cutter blade and the recording sheet may interfere, resulting in paper jam (sheet jam). On the other hand, in the case where the cutter blade is withdrawn to the home position before the transport of the recording sheet is restarted, paper jam can be inhibited but the throughput may decline since the transport of the recording sheet will not be performed until the cutter blade returns to the home position.

### SUMMARY

An advantage of some aspects of the invention is that, in a printer that includes a cutter, both improvement of the throughput in the case where continual printing is performed and inhibition of sheet jam are favorably achieved.

One aspect of the invention provides a control method for a printer that includes a cutter blade for cutting a recording sheet. The control method includes performing a cutting operation of cutting the recording sheet by using the cutter blade, the cutting operation including a braking operation of braking the cutter blade after the recording sheet is cut, and also includes stopping transporting the recording sheet and starting the cutting operation, and starting transporting the recording sheet while the braking operation is being performed.

Another aspect of the invention provides a printer that includes a cutter blade, a cutter drive unit that drives the cutter blade to perform an operation of cutting a recording sheet, and a transporter that transports the recording sheet. During a state in which the transporter has stopped transporting the recording sheet, the cutter drive unit starts the operation of cutting the recording sheet with the cutter blade. While the cutter drive unit is performing a braking operation of braking the cutter blade, the transporter starts transporting the recording sheet.

According to the printer and the control method for the printer in the foregoing aspects of the invention, when the recording sheet is cut by using the cutter blade, the braking operation and the transporting operation of the recording sheet can be concurrently performed. Therefore, the throughput in the case where continual printing is performed improves. Furthermore, since the recording sheet is not transported until the braking operation starts, the transport of the recording sheet is started after the cutter blade has moved apart from the sheet transport path. Therefore, sheet jam can be inhibited.

In the foregoing control method for the printer, the cutter blade may cut the recording sheet as the cutter blade is moved between a standby position and a shearing position, a braking start position at which to start braking the cutter blade may be provided between the standby position and the shearing position, and the braking operation may be performed based on detection that the cutter blade has returned from the shearing position to the braking start position.

In the foregoing printer, the cutter drive unit may move the cutter blade between a standby position and a shearing position so that the recording sheet is cut by the cutter blade and may start braking the cutter blade at a braking start position between the standby position and the shearing position, a detector that detects that the cutter blade is at the braking start position may be provided, and the transporter may start transporting the recording sheet after the detector detects that the cutter blade has returned from the shearing position to the braking start position.

By controlling the operation of the cutter blade after detecting the position of the cutter blade, the cutter blade can be accurately operated.

In the control method according to the invention, printing on the recording sheet may be started while the braking operation is being performed. The printer according to the invention may further include a printing unit that prints on the recording sheet and the printing unit may start printing on the recording sheet while the cutter drive unit is performing the braking operation of braking the cutter blade. This makes it possible to start printing before the recording sheet stops, the throughput at the time of continual printing will improve.

In the control method according to the invention, transporting the recording sheet may be started simultaneously with start of the braking operation. This will improve the throughput in the case where continual printing is performed.

In the printer according to the invention, the cutter drive unit may include an electric motor that drives the cutter blade and a bridge circuit to which the electric motor is connected, and a controller that switches between a cutting mode in which the recording sheet is cut by the cutter blade and a braking mode in which the cutter blade is braked, by controlling on/off state of a switch provided in the bridge circuit may be provided. This makes it possible to perform the braking operation by a simple circuit configuration and simple control.

In the printer according to the invention, the cutter drive unit, during the cutting mode, may move the cutter blade back and forth between the standby position and the shearing position based on rotation of the electric motor in one direction. This makes it unnecessary to reverse rotation of the motor, so that the back-and-forth motion of the cutter blade can be accomplished by simple control.

### BRIEF DESCRIPTION OF THE DRAWINGS

The invention will be described with reference to the accompanying drawings, wherein like numbers reference like elements.

FIG. 1 is a general construction diagram of a printer to which an exemplary embodiment of the invention has been applied.

FIG. 2 is an illustrative diagram of a cutter mounted in the printer illustrated in FIG. 1.

FIG. 3 is an illustrative diagram of a cutter mounted in the printer illustrated in FIG. 1.

FIG. 4 is a schematic block diagram illustrating a control system of the printer.

FIG. 5 is an illustrative diagram of a bridge circuit.

FIG. 6 is an illustrative diagram of drive modes of a motor of the cutter.

FIG. 7 is a flowchart illustrating a control of the printer.

### DESCRIPTION OF EXEMPLARY EMBODIMENTS

Exemplary embodiments of printers to which exemplary embodiments of the invention are applied will be described hereinafter with reference to the accompanying drawings.

Overall Construction

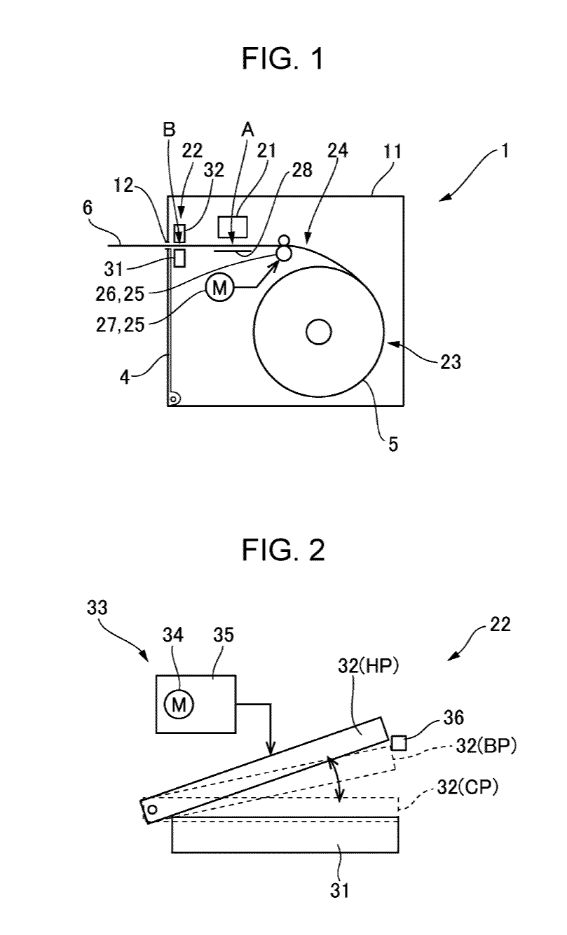

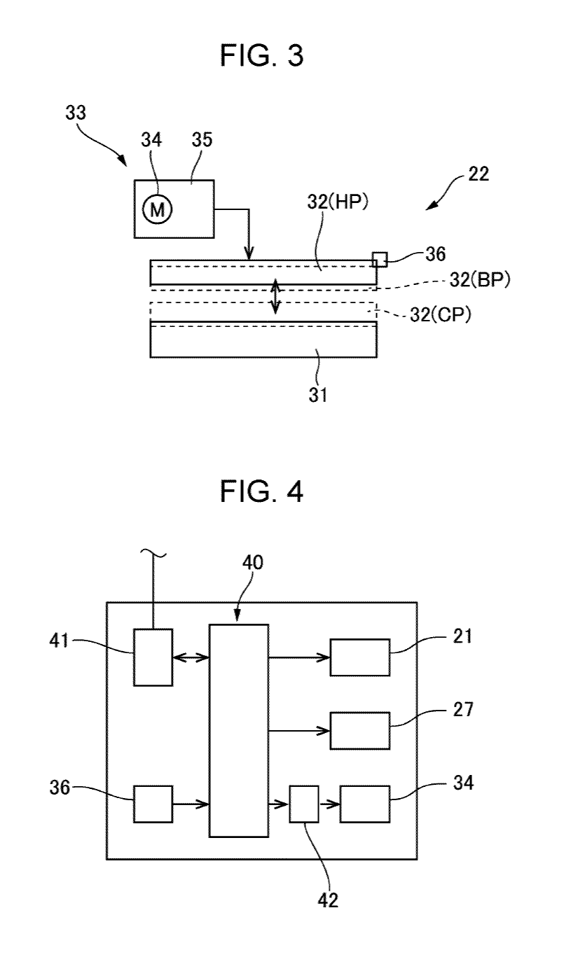

FIG. 1 is a general construction diagram of a printer to which an exemplary embodiment of the invention is applied. FIG. 2 and FIG. 3 are illustrative diagrams of a cutter mounted in the printer illustrated in FIG. 1. As illustrated in FIG. 1, a printer 1 includes a printer case 11 that has a rectangular parallelepiped shape as a whole. An upper portion of a front surface of the printer case 11 is provided with a discharge port 12 through which a recording sheet 6 is sent out. An opening/closing cover 4 is provided below the discharge port 12.

The printer 1 includes a print head 21 and a cutter 22 that are disposed within the printer case 11. The cutter 22 is an automatic cutter. The cutter 22 is disposed near the discharge port 12. The print head 21 is disposed behind the cutter 22 when seen from the discharge port 12. Also in a view from the discharge port 12, a paper roll housing portion 23 is provided behind the print head 21. When the opening/closing cover 4 is open, the paper roll housing portion 23 assumes an open state. The paper roll housing portion 23 is loaded with a paper roll 5 formed by rolling an elongated recording sheet 6.

Inside the printer case 11 there is provided a sheet transport path 24 extending from the paper roll housing portion 23 to the discharge port 12. The sheet transport path 24 is a transport path extending to the discharge port 12 via a printing position A at which printing is performed on the recording sheet 6 by the print head 21 and a cut position B at which the recording sheet 6 is cut by the cutter 22. The recording sheet 6 is drawn out onto the sheet transport path 24 from the paper roll 5 loaded on the paper roll housing portion 23. The printer 1 also includes a transporter 25 that transports the recording sheet 6 along the sheet transport path 24. The transporter 25 includes a transport roller 26 and a transport motor 27 that acts as a drive source of the transport roller 26.

At the printing position A for the printing by the print head 21 there is disposed a platen 28 facing the print head 21. In the case where the print head 21 is a thermal head, a platen roller that serves also as a transport roller is disposed at the printing position A for printing by the print head 21.

Cutter

As illustrated in FIG. 2 and FIG. 3, the cutter 22 includes a stationary blade 31 (second blade), a movable blade 32 (first blade) that is a cutter blade movable to and away from (movable relative to) the stationary blade 31, and a cutter drive unit 33 (see FIGS. 2 and 3) that drives the movable blade 32 to cut the recording sheet 6. The stationary blade 31 and the movable blade 32 face each other across the sheet transport path 24. In a form illustrated in FIG. 2 and FIG. 3, the stationary blade 31 and the movable blade 32 are disposed at a lower side and an upper side, respectively, of the sheet transport path 24. Alternatively, the stationary blade 31 may be disposed at the upper side of the sheet transport path 24 and the movable blade 32 at the lower side thereof. The stationary blade 31 is disposed at the cut position B on the sheet transport path 24.

As illustrated in FIGS. 2 and 3, the cutter drive unit 33 moves the movable blade 32 back and forth between the cutting position CP and the home position HP. The cutting position CP is a position at which the movable blade 32 comes into sliding contact with the stationary blade 31 to cut the recording sheet 6 on the sheet transport path 24. The home position HP is a position at which the movable blade 32 is apart from the stationary blade 31 and does not interfere with the recording sheet 6 lying on the sheet transport path 24. The cutter 22, when not used to cut the recording sheet 6, keeps the movable blade 32 standby at the home position HP. That is, the cutting position CP is a shearing position and the home position HP is a standby position.

When the printer 1 is supplied with print data from a host apparatus (not depicted), the transport motor 27 is driven to transport the recording sheet 6 along the sheet transport path 24. Furthermore, the print head 21 is driven to perform printing on the recording sheet 6 that passes through the printing position A. In the case where the print data includes a cutting command to cut the recording sheet 6, the cutter 22 is driven on the basis of the cutting command so that the recording sheet 6 is cut at the cut position B. The cut recording sheet 6 is sent out through the discharge port 12.

In an example of the cutter 22 mounted in the printer 1, a movable blade 32 is turned relative to the stationary blade 31 as illustrated in FIG. 2. In the cutter 22 as illustrated in FIG. 2, the cutter drive unit 33 includes a cutter motor 34 that serves as a drive source and a motion conversion mechanism 35 that includes gears, a cam, etc. and that converts rotational drive force from the cutter motor 34 into back-and-forth pivoting motion of the movable blade 32. The movable blade 32 pivots back and forth between the home position HP at which an edge portion thereof assumes an oblique posture to an edge portion of the stationary blade 31 and the cutting position CP at which the edge portion of the movable blade 32 and the edge portion of the movable blade 32 overlap each other in parallel.

Furthermore, the cutter 22 provided in the printer 1 may instead be a cutter 22 in which the movable blade 32 linearly moves to and away from the stationary blade 31 as illustrated in FIG. 3. In the cutter 22 as illustrated in FIG. 3, the cutter drive unit 33 includes a cutter motor 34 that serves as a drive source and a motion conversion mechanism 35 that converts rotational drive force from the cutter motor 34 into back-and-forth linear motion of the movable blade 32. The movable blade 32 moves back and forth between the home position HP at which an edge portion thereof is apart from an edge portion of the stationary blade 31 and the cutting position CP at which the edge portion of the movable blade 32 overlaps the edge portion of the stationary blade 31.

In this exemplary embodiment, the cutter motor 34 is a direct-current (DC) motor, and the motion conversion mechanism 35 moves the movable blade 32 back and forth on the basis of unidirectional rotation of the cutter motor 34. Furthermore, the cutter 22 includes a cutter sensor 36 that is a detector that detects the movable blade 32 at a predetermined position. The cutter sensor 36 detects that the movable blade 32 is at a braking start position BP between the cutting position CP and the home position HP. The cutter sensor 36 may be a sensor (a contact type mechanical sensor, an optical sensor, etc.) that directly detects the movable blade 32. Alternatively, a sensor that detects the position of the movable blade 32 on the basis of the rotation angle position of a gear or the like that constitutes the motion conversion mechanism 35.

Control System

FIG. 4 is a schematic block diagram illustrating a control system of the printer 1. The control system of the printer 1 includes a controller 40 that includes a processing apparatus such as a central processing unit (CPU). The controller 40 is connected to a communicator 41 for performing communication with a host apparatus. The cutter sensor 36 is connected to an input side of the controller 40. The input side of the controller 40 is also connected to a sheet detector (not depicted) disposed on the sheet transport path 24, a cover detector (not depicted) that detects an open/closed state of the opening/closing cover 4 provided in the printer case 11, etc. An output side of the controller 40 is connected to the print head 21, the transport motor 27, and the cutter motor 34.

The controller 40, the communicator 41, and the bridge circuit 42 are packaged on a substrate provided within the printer 1. The controller 40 includes a CPU (processor), a read-only memory (ROM) that is a non-volatile memory, such as a flash ROM, a random access memory (RAM) that is a volatile memory, an application specific integrated circuit (ASIC), a signal processing circuit, etc., and controls various portions of the printer 1. The controller 40 executes various processes, by using hardware and software combined, for example, executes a process as the CPU reads out a program, such as firmware, that is stored in the ROM or the RAM, or, for example, executes a process by using functions packaged in the ASIC, or, for example, executes a process by performing signal processing in a signal processing circuit. Furthermore, the CPU performs computations and the like by reading out various data stored in the ROM, writing the read-out data in the RAM, and using the RAM as a work area.

The controller 40, when supplied with print data from the host apparatus via the communicator 41, transports the recording sheet 6 along the sheet transport path 24 by driving the transport motor 27. Furthermore, the controller 40 drives the print head 21 to perform printing based on the print data on the recording sheet 6 passing through the printing position A. Furthermore, when the print data includes a cutting command, the controller 40 drives the cutter motor 34 to perform a cutting operation in which the movable blade 32 is moved back and forth between the home position HP and the cutting position CP. When the movable blade 32 moves to the cutting position CP, the recording sheet 6 is cut.

Operation Control of Cutter

As illustrated in FIG. 2 and FIG. 3, when the movable blade 32 returns from the cutting position CP to the home position HP, the movable blade 32 passes through the braking start position BP that is at a near side of the home position HP. When the movable blade 32 reaches the braking start position BP while moving toward the home position HP, the controller 40 starts a braking operation for stopping the movable blade 32. If the braking operation starts at the braking start position BP, the movable blade 32 stops at the home position HP. That is, a cutting operation in which the cutter 22 cuts the recording sheet 6 includes the braking operation of braking the movable blade 32 after the recording sheet 6 is cut.

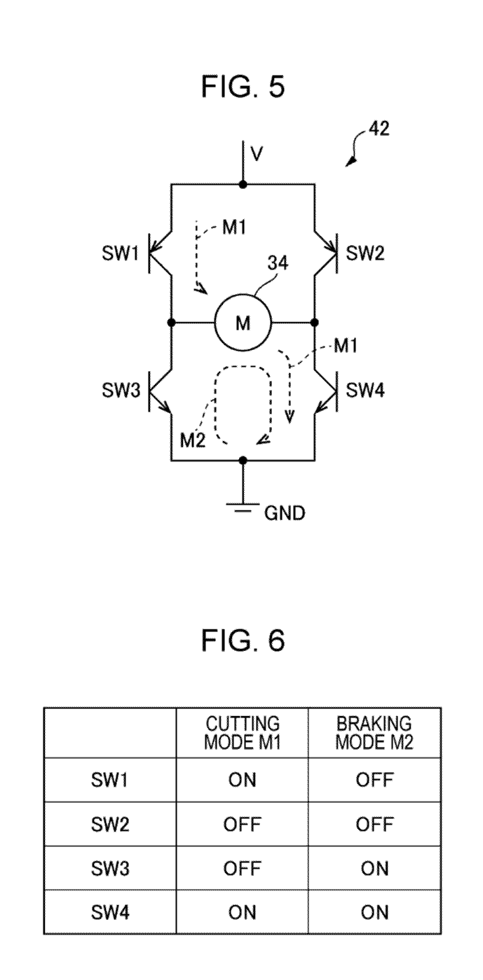

FIG. 5 is an illustrative diagram of a bridge circuit. FIG. 6 is an illustrative diagram of drive modes of the cutter motor 34. The control system of the printer 1 includes a bridge circuit 42 that controls electrification of the cutter motor 34. The controller 40 switches between the drive modes of the movable blade 32 by controlling the on and off states of switches SW1 to SW4 that are provided in the bridge circuit 42. The printer 1 is provided with two kinds of drive modes of the cutter motor 34, that is, a cutting mode M1 and a braking mode M2. Incidentally, the switches SW1 to SW4 are each made up of a transistor.

As illustrated in FIG. 6, during the cutting mode M1, the switch SW1 and the switch SW4 are switched to the on state and the switch SW2 and the switch SW3 are switched to the off state. At this time, as illustrated in FIG. 5, current supplied from an electric power supply V flows through the cutter motor 34 in a direction such that current flows through the switch SW1 and the switch SW4 in order. Therefore, the cutter motor 34 rotates forward, moving the movable blade 32 in such a direction as to cut the recording sheet 6. During the braking mode M2, on the other hand, the switch SW1 and the switch SW2 are switched to the off state and the switch SW3 and the switch S4 are switched to the on state. During this state, the electric power supply V does not supply current to the cutter motor 34. Regenerative current flows through the interior of the cutter motor 34 in the direction from the switch SW3 to the switch SW4 and damps the rotation of the cutter motor 34. Therefore, the movable blade 32 is braked.

When the movable blade 32, after starting to move, does not return to the home position HP within a predetermined length of time, the controller 40 determines that abnormality, such as sheet jam, has occurred. In that case, the controller 40 temporarily switches the switches SW1 to SW4 (all the switches) to the off state, and then switches the switch SW2 and the switch SW3 to the on state, so that the cutter motor 34 reversely rotates to return the movable blade 32.

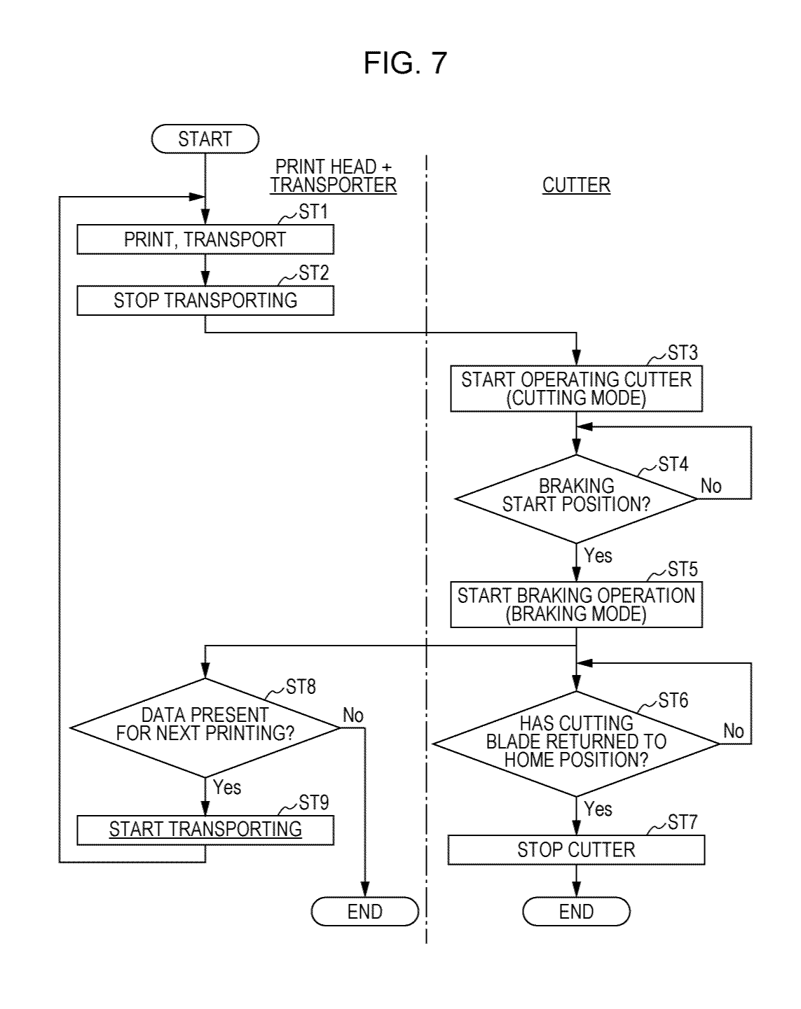

FIG. 7 is a flowchart illustrating control of the printer 1 during continual printing. The controller 40 of the printer 1, after receiving print data, controls the transport motor 27 so as to transport the recording sheet 6 along the sheet transport path 24 as described above. Furthermore, the controller 40 drives the print head 21 to perform printing based on print data on the recording sheet 6 passing through the printing position A (step ST1). When print data includes the cutting command, the controller 40 transports the recording sheet 6 to a predetermined transport position in step ST1. Then, the controller 40 stops transporting the recording sheet 6 (step ST2). In step ST2, the recording sheet 6 is stopped after a printed area on the recording sheet 6 has passed the cut position B on the sheet transport path 24. For example, the recording sheet 6 is stopped so that a predetermined position between a print area where printing for one whole cut sheet has been performed and a print area where the next printing is to be performed coincides with the cut position B on the sheet transport path 24.

Next, the controller 40 starts driving the cutter motor 34 (step ST3). In step ST3, the operation mode of the cutter motor 34 is the cutting mode M1. Therefore, the movable blade 32 performs an operation of moving from the home position HP to the cutting position CP, cutting the recording sheet 6, and then moving from the cutting position CP to the home position HP. The controller 40, while driving the cutter motor 34 in the cutting mode M1, monitors whether the movable blade 32 has reached the braking start position BP (step ST4). In step ST4, based on the output from the cutter sensor 36 described above, the controller 40 detects that the movable blade 32, while moving toward the home position HP, has reached the braking start position BP. After the movable blade 32 reaches the braking start position BP (Yes in step ST4), the process proceeds to step ST5.

In step ST5, the controller 40 switches the operation mode of the cutter motor 34 from the cutting mode M1 to the braking mode M2. Therefore, the braking of the movable blade 32 starts. After a predetermined time elapses following the switching of the operation mode of the cutter motor 34 to the braking mode M2, the controller 40 stops driving the cutter motor 34. For example, after switching the operation mode of the cutter motor 34 to the braking mode M2, the controller 40 maintains the braking mode M2 and continues braking for 100 msec, and then switches the switches SW1 to SW4 to the off state to stop driving the cutter motor 34. Therefore, in step ST6, the controller 40 monitors the elapsed time after switching the operation mode of the cutter motor 34 to the braking mode M2. When the elapsed time reaches 100 msec (Yes in step ST6), the controller 40 stops driving the cutter motor 34 (step ST7).

The controller 40 controls the transport motor 27 concurrently with controlling the cutter motor 34. When print data received include print data subsequently to the cutting command (Yes in step ST8), the controller 40 starts transporting the recording sheet 6 while the cutter motor 34 is operating in the braking mode M2, in order to perform the next printing. In this exemplary embodiment, the controller 40 starts driving the transport motor 27 within 100 msec after the operation mode of the cutter motor 34 is switched from the cutting mode M1 to the braking mode M2 (step ST9). On the other hand, when there are no data for the next printing (No in step ST8), the controller 40 does not start transporting the recording sheet 6.

The start of driving the transport motor 27, for example, in the case where the transport motor 27 is a stepper motor, may be the start of electrification such as “Rush” or “Hold”. Alternatively, the start of driving the transport motor 27 may also be the start of switching the phase. Instead of being fixed at 100 msec, the time setting may be variable by the controller 40 on the basis of the state of braking. Furthermore, on the basis of the state of braking, the controller 40 sets the timing of starting to drive the transport motor 27 to an appropriate timing within 100 msec. In the case where the effect of braking manifests itself early, the driving is started at an early timing. In the case where the effect of braking manifests itself late, the driving is started at a late timing. This ensures that the movable blade 32 will move apart from the sheet transport path 24 so as to avoid sheet jam.

After starting to transport the recording sheet 6 in step ST9, the controller 40 returns to step ST1. Then, the controller 40 drives the print head 21 to perform printing on the recording sheet 6.

### Main Advantageous Effects of the Exemplary Embodiment

As described above, in the printer 1 of this exemplary embodiment, the cutting operation in which the movable blade 32 is driven by the cutter motor 34 to cut the recording sheet 6 and the cutting operation includes a braking operation of braking the movable blade 32. The braking operation of braking the movable blade 32 and the operation of transporting the recording sheet 6 for the next printing are concurrently performed. Therefore, when continual printing on a plurality of cut sheets is carried out, the recording sheet 6 starts to be transported before the movable blade 32 returns to the home position HP. Thus, throughput improves. Furthermore, since the recording sheet 6 is not transported until the braking operation is started by switching the cutter motor 34 to the braking mode M2, the recording sheet 6 is not transported until the movable blade 32 is apart from the sheet transport path 24. Therefore, sheet jam can be inhibited.

In this exemplary embodiment, it is detected via the cutter sensor 36 that the movable blade 32 has reached the braking start position BP, and the control of switching the cutter motor 34 to the braking mode M2 is performed. Therefore, the movable blade 32 can be accurately operated.

In this exemplary embodiment, the cutter motor 34 is connected to the bridge circuit 42, and the on/off states of the switch SW1 to SW4 provided in the bridge circuit 42 are controlled to switch between the drive modes of the cutter motor 34. This allows the switching between the cutting mode and the braking operation to be accomplished by a simple circuit configuration and simple control.

### Modifications

(1) Although in the foregoing exemplary embodiment, the operation mode of the cutter motor 34 is switched to the braking mode M2 before the recording sheet 6 starts to be transported, the timing at which the operation mode of the cutter motor 34 is switched to the braking mode M2 (the timing at which the braking operation is started) and the timing at which the transport of the recording sheet 6 is started may be simultaneous. This will further improve the throughput at the time of continual printing.

(2) Although in the foregoing exemplary embodiment, the transport of the recording sheet 6 is started and the process goes back to step ST1 to perform the next printing, the next printing can be performed instead by starting to drive the print head 21 while the cutter motor 34 is operating in the braking mode M2. Due to this, the printing operation, as well as the transport operation, can be performed concurrently with the braking operation. Therefore, the throughput at the time of continual printing can be further improved.

(3) Although in the foregoing exemplary embodiment, the driving of the cutter motor 34 is stopped after a predetermined time (e.g., 100 msec) elapses following the switching of the operation mode of the cutter motor 34 to the braking mode M2, the driving duration in the braking mode M2 may be different from 100 msec. Furthermore, a sensor for detecting the movable blade 32 being positioned at the home position HP may be provided and, on the basis of detection of the movable blade 32 by this sensor, the control of stopping driving the cutter motor 34 may be performed.

Furthermore, the function blocks described above with reference to the drawings can be arbitrarily realized on the basis of cooperation of hardware and software. Furthermore, none of the function blocks described above indicates any specific hardware configuration.

What is claimed is:

1. A control method for a printer that includes a cutter blade for cutting a recording sheet, the control method comprising:
performing a cutting operation of cutting the recording sheet by using the cutter blade, the cutting operation including a braking operation of braking the cutter blade after the recording sheet is cut;
stopping transporting the recording sheet and starting the cutting operation; and
starting transporting the recording sheet while the braking operation is being performed.

2. The control method according to claim 1, wherein:
the cutter blade cuts the recording sheet as the cutter blade is moved between a standby position and a shearing position;
a braking start position at which to start braking the cutter blade is provided between the standby position and the shearing position; and
the braking operation is performed based on detection that the cutter blade has returned from the shearing position to the braking start position.

3. The control method according to claim 1, wherein printing on the recording sheet is started while the braking operation is being performed.

4. The control method according to claim 1, wherein transporting the recording sheet is started simultaneously with start of the braking operation.

5. A printer comprising:
a cutter blade;
a cutter drive unit that drives the cutter blade to perform an operation of cutting a recording sheet; and
a transporter that transports the recording sheet,
wherein, during a state in which the transporter has stopped transporting the recording sheet, the cutter drive unit starts the operation of cutting the recording sheet with the cutter blade, and
wherein, while the cutter drive unit is performing a braking operation of braking the cutter blade, the transporter starts transporting the recording sheet.

6. The printer according to claim 5, wherein:
the cutter drive unit moves the cutter blade between a standby position and a shearing position so that the recording sheet is cut by the cutter blade and starts braking the cutter blade at a braking start position between the standby position and the shearing position;
a detector that detects that the cutter blade is at the braking start position is provided; and
the transporter starts transporting the recording sheet after the detector detects that the cutter blade has returned from the shearing position to the braking start position.

7. The printer according to claim 5, wherein:
the cutter drive unit includes an electric motor that drives the cutter blade and a bridge circuit to which the electric motor is connected; and
a controller that switches between a cutting mode in which the recording sheet is cut by the cutter blade and a braking mode in which the cutter blade is braked, by controlling on/off state of a switch provided in the bridge circuit is provided.

8. The printer according to claim 7, wherein the cutter drive unit, during the cutting mode, moves the cutter blade back and forth between the standby position and the shearing position based on rotation of the electric motor in one direction.

9. The printer according to claim 5, further comprising
a printing unit that prints on the recording sheet,
wherein the printing unit starts printing on the recording sheet while the cutter drive unit is performing the braking operation of braking the cutter blade.
